(19) United States
(12) Patent Application Publication
(10) Pub. No.: US 2026/0268783 A1
(43) Pub. Date: Sep. 10, 2026

(54) Magnetic Learning Block System with Encapsulated Self-Aligning Spherical Magnets

(71) Applicant: Yehonatan Assouline, Rehovot (IL)

(72) Inventor: Yehonatan Assouline, Rehovot (IL)

(21) Appl. No.: 19/666,320

(22) Filed: May 3, 2026

Related U.S. Application Data
(60) Provisional application No. 63/765,823, filed on Mar. 3, 2025.

(51) Int. Cl. G09B 1/38; B33Y 10/00; B33Y 80/00

(52) U.S. Cl. CPC G09B 1/38; B33Y 80/00; B33Y 10/00

(57) ABSTRACT

A physical phonics learning system includes a set of consonant letter block elements and a set of vowel hub elements. Each consonant letter block element bears at least one consonant character, and each vowel hub element bears at least one vowel character and has a geometry different from the consonant letter block elements. The elements include fully encapsulated spherical magnetic members disposed within fully enclosed internal cavities. The cavities permit rotation of the spherical magnetic members while preventing user access to the magnetic members during normal use. The spherical magnetic members self-align with magnetic members of adjacent elements to provide removable, direct, polarity-independent magnetic coupling without requiring a board, rail, frame, or ferromagnetic support surface. The elements may be manually arranged, connected, separated, and rearranged to form consonant-vowel-consonant word configurations, vowel-substitution word configurations, and other phonics learning arrangements.

### 2. FIELD OF THE INVENTION

This invention relates to physical educational learning systems, and more particularly to modular phonics and word-building systems using magnetically connectable learning elements.

The invention further relates to magnetic modular components having fully encapsulated, rotatable spherical magnetic members that enable direct, polarity-independent magnetic coupling between physical learning elements without requiring a board, rail, frame, or ferromagnetic support surface.

In some embodiments, the invention relates to a phonics learning system comprising consonant letter block elements and geometrically distinct vowel hub elements that can be manually connected, separated, and rearranged to form consonant-vowel-consonant word configurations and vowel-substitution word configurations.

### 3. BACKGROUND OF THE INVENTION

Physical alphabet blocks, magnetic letters, phonics tiles, and word-building manipulatives are commonly used to support early literacy and phonics instruction. Many existing systems rely on flat magnetic letters attached to a ferromagnetic board, printed cards, rails, trays, or other external support structures. Other systems use blocks or tiles bearing letters, colors, or phonics markings to guide word-building activities.

However, many conventional systems do not provide direct, free-form magnetic coupling between individual letter-bearing components. Systems that rely on ferromagnetic boards or support surfaces can limit spatial manipulation, while systems using fixed-polarity magnets may require a predetermined orientation for successful attachment. In addition, exposed or removable magnets can present safety concerns in products intended for children.

There remains a need for a physical phonics learning system in which letter-bearing and vowel-bearing elements can be directly connected to one another, rearranged by hand, and used to form phonetic word structures without requiring an external board or predefined magnetic polarity orientation. There is also a need for a safer magnetic construction in which magnetic members are fully encapsulated within the learning elements while remaining capable of self-alignment for magnetic coupling.

### 4. SUMMARY OF THE INVENTION

The invention provides a physical phonics learning system comprising a set of consonant letter block elements and a set of vowel hub elements. Each consonant letter block element may include a body bearing at least one consonant character. Each vowel hub element may include a body bearing at least one vowel character and may have a geometry different from the geometry of the consonant letter block elements.

In some embodiments, each consonant letter block element and each vowel hub element includes one or more fully encapsulated spherical magnetic members disposed within one or more fully enclosed internal cavities of the respective body. Each internal cavity may be dimensioned to permit rotation of the spherical magnetic member while preventing user access to the spherical magnetic member from outside the body during normal use.

The spherical magnetic members are configured to magnetically self-align with magnetic members of adjacent elements. This enables removable, direct, polarity-independent magnetic coupling between consonant letter block elements and vowel hub elements without requiring a board, rail, frame, or ferromagnetic support surface.

In some embodiments, the vowel hub elements include polygonal bodies having a plurality of peripheral connection regions. In a preferred embodiment, each vowel hub element has a generally pentagonal body with five peripheral connection regions. The vowel hub element may function as a central hub around which consonant letter block elements can be connected and rearranged.

The system allows users to manually arrange, connect, separate, and rearrange the consonant letter block elements and vowel hub elements to form phonetic structures, including consonant-vowel-consonant word configurations and vowel-substitution word configurations.

In some embodiments, the system elements are manufactured by additive manufacturing. A spherical magnetic member may be inserted into a partially formed internal cavity during a paused stage of the additive manufacturing process, after which the manufacturing process is resumed to fully enclose the spherical magnetic member within the body. In other embodiments, other manufacturing methods may be used to form a fully enclosed internal cavity around a rotatable spherical magnetic member.

### 5. BRIEF DESCRIPTION OF THE DRAWINGS

FIG. 1 is a perspective view of a consonant letter block element according to one embodiment of the invention.

FIG. 2 is a perspective view of a vowel hub element according to one embodiment of the invention.

FIG. 3 is a side sectional view of a consonant letter block element showing fully encapsulated spherical magnetic members disposed within fully enclosed internal cavities.

FIG. 4 is a top sectional view of a vowel hub element showing spherical magnetic members positioned adjacent to peripheral connection regions of the vowel hub element.

FIG. 5 is a top sectional schematic view showing direct magnetic coupling between a consonant letter block element and a vowel hub element by self-alignment of encapsulated spherical magnetic members.

FIG. 6 is a perspective view of an alternative larger consonant letter block element having two fully encapsulated spherical magnetic members adjacent to each side face.

FIG. 7 is a schematic view of a consonant-vowel-consonant word configuration formed by two consonant letter block elements and one vowel hub element.

FIG. 8 is a schematic manufacturing sequence showing additive manufacturing of a first body portion, placement of spherical magnetic members into partially formed cavities, and resuming manufacturing to fully encapsulate the spherical magnetic members.

### 6. DETAILED DESCRIPTION

The following description sets forth embodiments of a physical phonics learning system. The embodiments are provided to illustrate the invention and are not intended to limit the scope of the claims. Features described with respect to one embodiment may be combined with features of other embodiments unless such combination is technically inconsistent.

In one embodiment, the physical phonics learning system includes a set of consonant letter block elements 12 and a set of vowel hub elements 14. The consonant letter block elements 12 may have generally rectangular bodies 16 bearing consonant characters 18, alphabetic characters, graphemes, phonetic symbols, or other phonics-related markings. The vowel hub elements 14 may have bodies 16 bearing vowel characters 20 and may have a geometry different from the geometry of the consonant letter block elements 12.

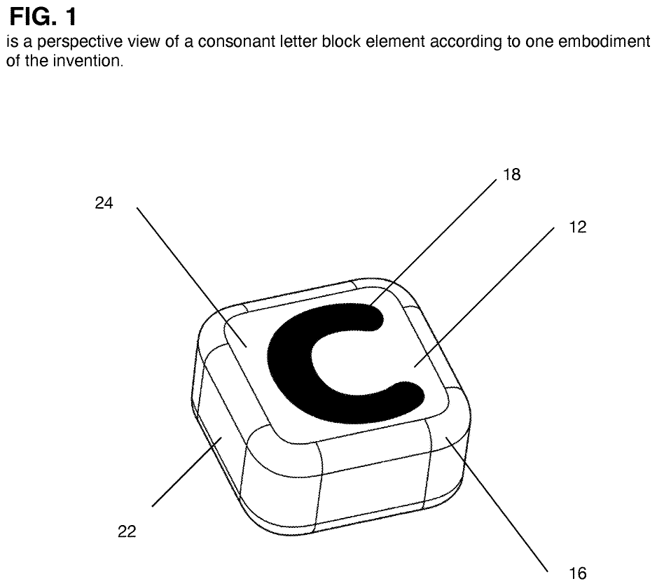

As shown in FIG. 1, a consonant letter block element 12 may include a body 16 having one or more side faces 22 and one or more major faces 24. In one embodiment, the consonant character 18 is disposed on a major face 24 of the body 16. The opposed major faces 24 may display uppercase and lowercase forms of a corresponding alphabetic character. In other embodiments, the opposed major faces 24 may display other alphabetic markings, grapheme markings, phonetic markings, symbols, numbers, icons, images, or other educational indicia.

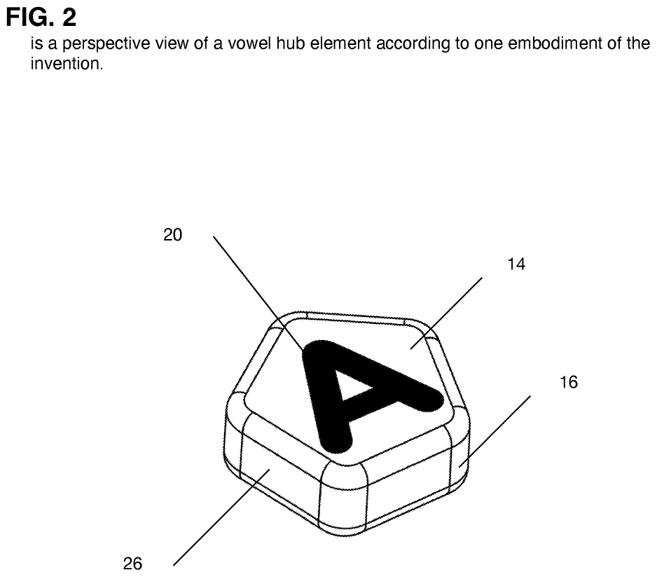

As shown in FIG. 2, a vowel hub element 14 may include a body 16 having a vowel character 20 disposed on a major face of the body 16. In one embodiment, the vowel hub element 14 includes a polygonal body 16 having a plurality of peripheral connection regions 26. In a preferred embodiment, the vowel hub element 14 includes five peripheral connection regions 26 and has a generally pentagonal body.

The vowel hub element 14 may function as a central node in a word-building configuration, with the peripheral connection regions 26 providing multiple possible attachment locations for consonant letter block elements 12. The hub function may be provided by the arrangement of connection regions rather than by any single required external shape. The five peripheral connection regions 26 allow the vowel hub element 14 to function as a central hub to which one or more consonant letter block elements 12 may be magnetically connected. Other polygonal, triangular, rectangular, square, hexagonal, circular, rounded, or irregular hub geometries may also be used, provided that the hub element is configured to support phonics-related word-building arrangements.

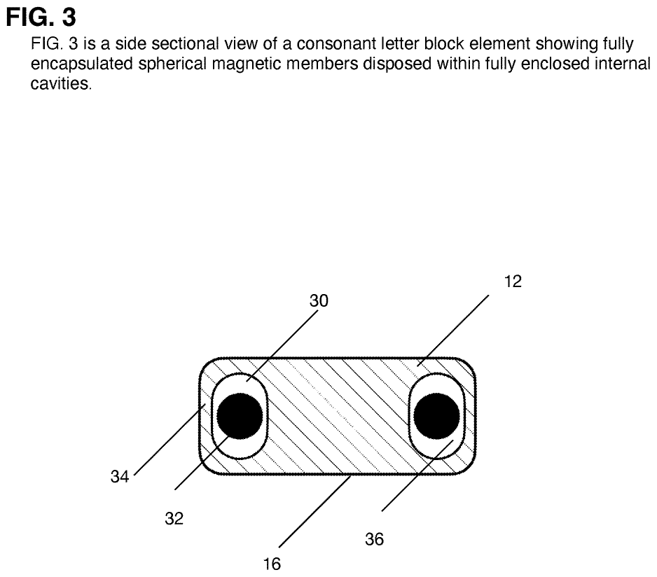

As shown in FIG. 3, each consonant letter block element 12 may include one or more fully enclosed internal cavities 30 formed within the body 16. Each fully enclosed internal cavity 30 may contain a spherical magnetic member 32. The spherical magnetic member 32 is fully encapsulated within the body 16 in a tamper-resistant manner so that the spherical magnetic member 32 is not exposed at an exterior surface and is not accessible from outside the body 16 during normal use. In some embodiments, the spherical magnetic member 32 may be substantially sealed or hermetically encapsulated within continuous body material 34.

The terms “fully encapsulated” and “fully enclosed” refer to the final structural condition of the spherical magnetic member 32 being surrounded by body material and not accessible from outside the body 16 during normal use, regardless of the particular manufacturing method used to form the body 16 or the cavity 30.

Each fully enclosed internal cavity 30 is dimensioned to permit rotation of the spherical magnetic member 32 within the cavity 30. A clearance 36 between the spherical magnetic member 32 and the internal cavity 30 allows the spherical magnetic member 32 to rotate in response to a magnetic field generated by another system element. This allows the spherical magnetic member 32 to magnetically self-align with a spherical magnetic member 32 or other magnetic element of an adjacent system element.

In some embodiments, the fully enclosed internal cavity 30 has an internal dimension greater than a diameter of the spherical magnetic member 32, thereby defining clearance 36 sufficient to permit rotation of the spherical magnetic member 32 within the cavity 30 while maintaining full encapsulation by the surrounding body material 34.

As further shown in FIG. 3, the spherical magnetic member 32 is separated from an exterior surface of the body 16 by continuous body material 34. The continuous body material 34 forms a body wall around the fully enclosed internal cavity 30 and prevents user access to the spherical magnetic member 32. The clearance 36 may be sufficient to allow rotation of the spherical magnetic member 32 while maintaining full encapsulation of the spherical magnetic member 32 within the body 16.

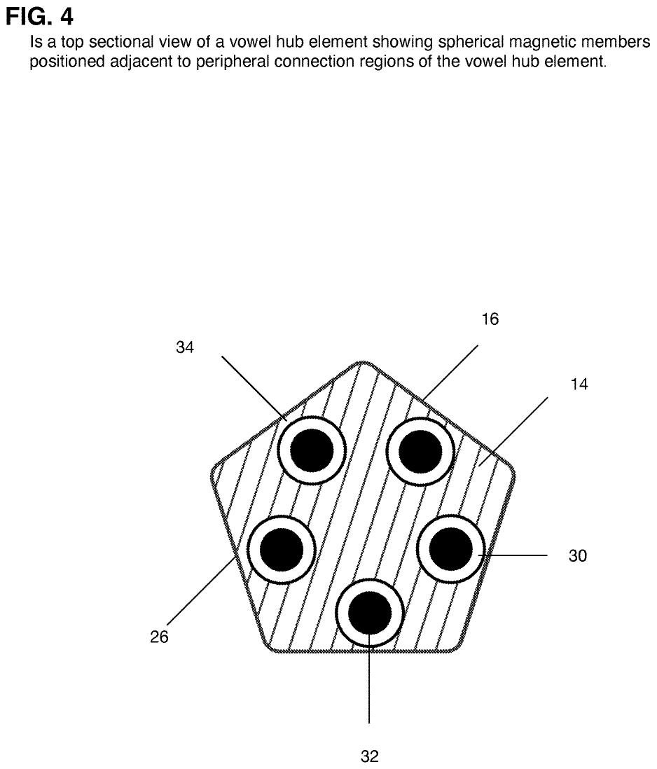

As shown in FIG. 4, a vowel hub element 14 may include a plurality of fully enclosed internal cavities 30, each containing a spherical magnetic member 32. The fully enclosed internal cavities 30 may be positioned adjacent to peripheral connection regions 26 of the vowel hub element 14. In a generally pentagonal vowel hub embodiment, one or more spherical magnetic members 32 may be positioned near each of five peripheral connection regions 26, allowing consonant letter block elements 12 to be attached at different positions around the vowel hub element 14.

The self-alignment of the spherical magnetic members 32 enables removable, direct, polarity-independent magnetic coupling between system elements. As a result, a user is not required to orient the elements according to a predetermined north-south polarity arrangement. When two system elements are brought into proximity, the spherical magnetic members 32 may rotate within their respective fully enclosed internal cavities 30 to align magnetically and establish an attractive magnetic connection.

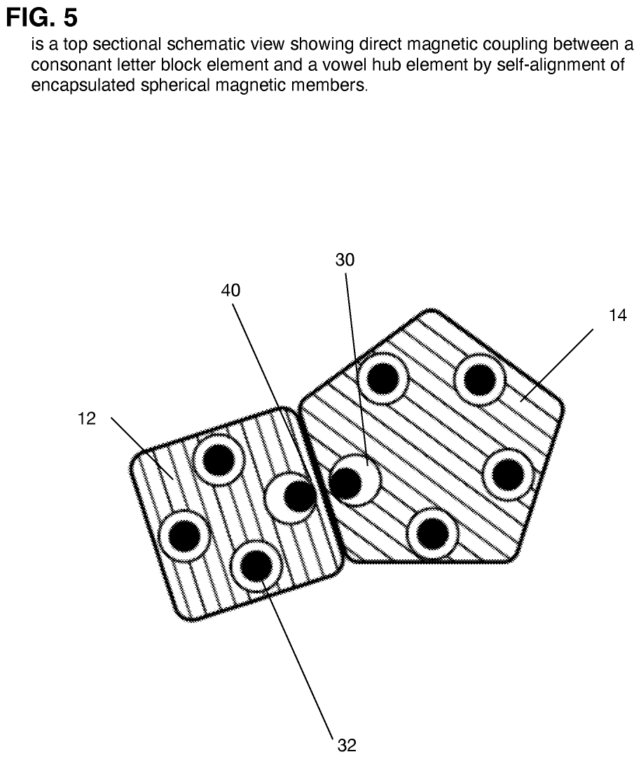

As shown in FIG. 5, a consonant letter block element 12 may be directly magnetically coupled to a vowel hub element 14 at a direct magnetic coupling interface 40. At the coupling interface 40, a spherical magnetic member 32 within a fully enclosed internal cavity 30 of the consonant letter block element 12 may self-align with a spherical magnetic member 32 within a fully enclosed internal cavity 30 of the vowel hub element 14. This allows the consonant letter block element 12 and the vowel hub element 14 to be removably connected without requiring a board, rail, frame, or ferromagnetic support surface.

The spherical magnetic members 32 may be positioned adjacent to side faces 22 or peripheral connection regions 26 of the respective bodies 16. In the consonant letter block elements 12, the spherical magnetic members 32 may be positioned adjacent to one or more side faces 22 to permit magnetic coupling from multiple side directions. In the vowel hub elements 14, the spherical magnetic members 32 may be positioned adjacent to one or more peripheral connection regions 26 to permit magnetic coupling of consonant letter block elements 12 around the vowel hub element 14.

In some embodiments, each consonant letter block element 12 includes one or more fully encapsulated spherical magnetic members 32 positioned along each of a plurality of side faces 22. In other embodiments, each consonant letter block element 12 includes a plurality of spherical magnetic members 32 along a side face 22 to increase coupling strength or improve alignment between adjacent elements.

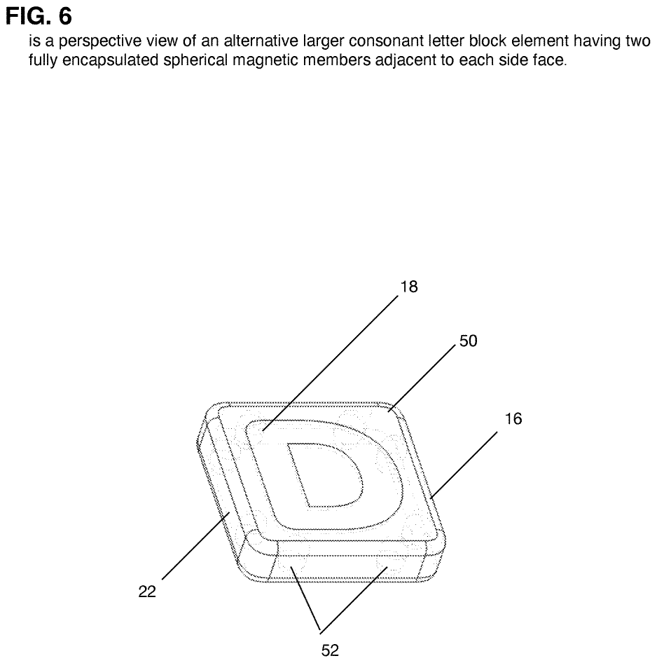

As shown in FIG. 6, an alternative larger consonant letter block element 50 may include a body 16 bearing a consonant character 18 and having side faces 22. In this embodiment, a pair of spherical magnetic members 52 may be positioned adjacent to each side face 22. The pair of spherical magnetic members 52 may be fully encapsulated within the body 16 and may provide increased magnetic coupling strength or improved alignment relative to embodiments having a single spherical magnetic member adjacent to a side face.

The system does not require a board, rail, frame, or ferromagnetic support surface. The magnetic connection is formed directly between the system elements by the interaction of the fully encapsulated spherical magnetic members 32. This allows the system elements to be connected, separated, rearranged, and reconnected by hand in different physical configurations. Although no ferromagnetic support surface is required, in some embodiments the fully encapsulated spherical magnetic members 32 may also permit attachment of one or more system elements to a ferromagnetic support surface, such as a magnetic board or metal surface.

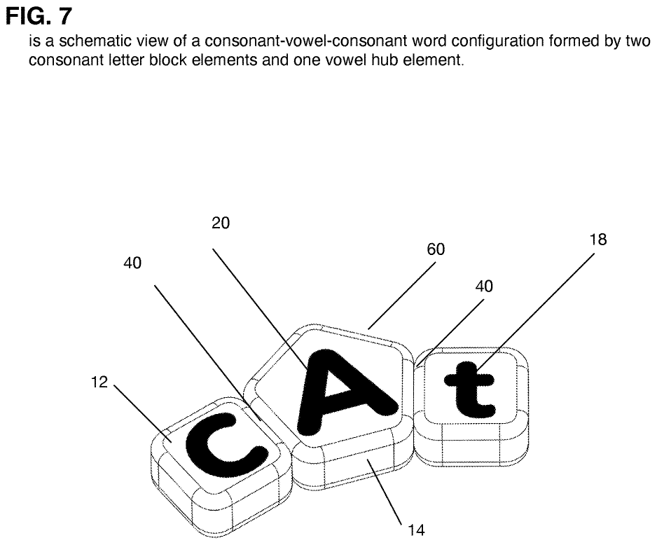

As shown in FIG. 7, the consonant letter block elements 12 and vowel hub elements 14 may be manually arranged to form a consonant-vowel-consonant word configuration 60. In one use configuration, two consonant letter block elements 12 may be magnetically coupled to opposite sides or peripheral connection regions 26 of a vowel hub element 14 to form a physical word configuration, such as a consonant-vowel-consonant word structure. In another use configuration, a vowel hub element 14 may be removed and replaced with another vowel hub element 14 to create vowel-substitution word configurations. This allows a user to physically manipulate word structures and observe how changing a vowel affects a word configuration.

In some embodiments, the system may be used with activity cards, worksheets, printed guides, or other instructional materials. The activity cards may display target word configurations, consonant-vowel-consonant structures, vowel-substitution patterns, word families, phonics prompts, or other learning tasks. The activity cards are optional and may guide the user in arranging the physical elements into phonetic word configurations.

In one embodiment, the bodies 16 of the consonant letter block elements 12 and vowel hub elements 14 are monolithic bodies. As used herein, a monolithic body may refer to a body formed as a single continuous body, rather than a body assembled from a main housing and separate sealing covers. The spherical magnetic members 32 are retained within fully enclosed internal cavities 30 of the monolithic bodies.

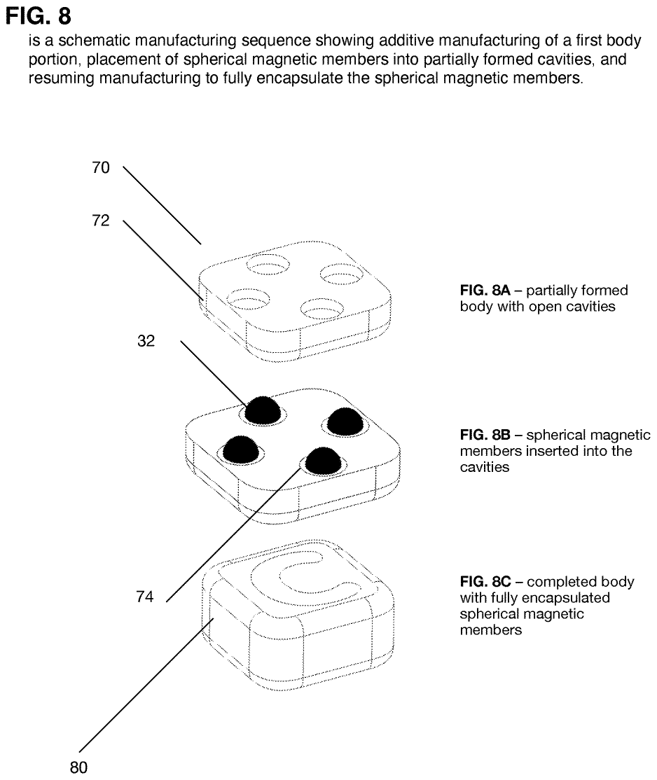

As shown in FIG. 8, in some embodiments the system elements are manufactured according to an additive manufacturing sequence 70. A partially formed body or first body portion 72 is additively manufactured to define at least part of a partially formed open cavity or magnet-receiving region 74. A spherical magnetic member 32 is then placed into the partially formed open cavity 74. The additive manufacturing process is then resumed to form additional body material over and around the spherical magnetic member 32, thereby creating a completed body 80 having a fully enclosed internal cavity 30 containing the spherical magnetic member 32.

This manufacturing approach allows the spherical magnetic member 32 to remain rotatable within the internal cavity 30 while being fully encapsulated by the body 16. The resulting element has no user-accessible opening through which the spherical magnetic member 32 can be removed during normal use.

The additive manufacturing process may include fused deposition modeling, fused filament fabrication, selective laser sintering, stereolithography, multi-jet fusion, or other additive manufacturing techniques capable of forming an internal cavity 30 around an inserted spherical magnetic member 32. In other embodiments, the bodies 16 may be manufactured by molding, overmolding, casting, machining, welding, bonding, or other manufacturing methods capable of forming a fully enclosed internal cavity 30 around a rotatable spherical magnetic member 32.

The body material may include polymeric material, plastic, thermoplastic, thermoset material, resin, composite material, nylon, PLA, PETG, ABS, ASA, polypropylene, polyethylene, polycarbonate, or other non-magnetic body materials. The spherical magnetic members 32 may include spherical permanent magnets, rare-earth magnets, neodymium magnets, ferrite magnets, or other magnetic members capable of rotating within an internal cavity 30 and self-aligning with another magnetic member.

The size, number, and placement of the spherical magnetic members 32 may vary according to the size and intended use of the system elements. In one embodiment, a smaller consonant letter block element 12 may include one spherical magnetic member 32 adjacent to each of a plurality of side faces 22. In another embodiment, a larger consonant letter block element 50 may include two or more spherical magnetic members 32 adjacent to each of a plurality of side faces 22. In one embodiment, a vowel hub element 14 may include one or more spherical magnetic members 32 adjacent to each peripheral connection region 26.

The internal cavity 30 may be generally spherical, rounded, cylindrical, or otherwise shaped to allow rotation of the spherical magnetic member 32. The internal cavity 30 may be larger than the spherical magnetic member 32 to provide rotational clearance 36, while the surrounding continuous body material 34 fully encloses the cavity 30 to prevent user access to the spherical magnetic member 32.

The system may be provided as a kit. The kit may include a plurality of consonant letter block elements 12, a plurality of vowel hub elements 14, and one or more activity cards or instructional materials. The kit may be configured for use in phonics learning, spelling practice, word-building, early literacy instruction, classroom activities, home learning, therapy, or fine motor skill development.

Although the embodiments described above relate primarily to phonics and word-building, the same fully encapsulated self-aligning spherical magnet structure may be used in other modular educational systems. For example, similar elements may be used for mathematics, symbols, coding, language learning, sequencing, pattern formation, or other educational activities requiring modular physical arrangement and rearrangement.

1. A physical phonics learning system comprising:
a set of consonant letter block elements, each consonant letter block element having a body bearing at least one consonant character;
a set of vowel hub elements, each vowel hub element having a body bearing at least one vowel character and having a geometry different from the geometry of the consonant letter block elements;
wherein each consonant letter block element and each vowel hub element includes one or more fully encapsulated spherical magnetic members disposed within one or more fully enclosed internal cavities of the respective body;
wherein each fully enclosed internal cavity is dimensioned to permit rotation of the respective spherical magnetic member within the cavity while preventing user access to the spherical magnetic member from outside the body;
wherein the spherical magnetic members are configured to magnetically self-align with spherical magnetic members of adjacent elements to enable removable, direct, polarity-independent magnetic coupling between the consonant letter block elements and the vowel hub elements without requiring a board, rail, frame, or ferromagnetic support surface; and
wherein the consonant letter block elements and vowel hub elements are configured to be manually arranged, connected, separated, and rearranged to form consonant-vowel-consonant word configurations and vowel-substitution word configurations.

2. The physical phonics learning system of claim 1, wherein each vowel hub element has a polygonal body including five peripheral connection regions.

3. The physical phonics learning system of claim 2, wherein each vowel hub element has a generally pentagonal body.

4. The physical phonics learning system of claim 1, wherein each consonant letter block element has a generally rectangular body including opposed major faces bearing alphabetic markings and side faces containing the fully encapsulated spherical magnetic members.

5. The physical phonics learning system of claim 4, wherein the opposed major faces of each consonant letter block element bear uppercase and lowercase forms of a corresponding alphabetic character.

6. The physical phonics learning system of claim 1, wherein the fully encapsulated spherical magnetic members are positioned adjacent to side faces or peripheral connection regions of the respective bodies to permit magnetic coupling from multiple directions.

7. The physical phonics learning system of claim 1, wherein each fully enclosed internal cavity provides clearance around the respective spherical magnetic member sufficient to allow the spherical magnetic member to rotate in response to a magnetic field generated by an adjacent element.

8. The physical phonics learning system of claim 1, wherein the spherical magnetic members are separated from exterior surfaces of the respective bodies by a wall of body material, such that the spherical magnetic members are not exposed at the exterior surfaces.

9. The physical phonics learning system of claim 1, wherein the bodies of the consonant letter block elements and vowel hub elements are monolithic bodies.

10. The physical phonics learning system of claim 1, wherein the bodies of the consonant letter block elements and vowel hub elements are additively manufactured bodies.

11. The physical phonics learning system of claim 1, further comprising one or more activity cards configured to guide arrangement of the consonant letter block elements and vowel hub elements into phonetic word configurations.

12. A method of manufacturing a physical phonics learning system element, the method comprising:
additively manufacturing a first portion of a body of the system element, the first portion defining at least part of an internal cavity;
pausing the additive manufacturing process;
placing a spherical magnetic member into the at least partially formed internal cavity; and
resuming the additive manufacturing process to form additional body material over the spherical magnetic member, thereby forming a fully enclosed internal cavity containing the spherical magnetic member;
wherein the fully enclosed internal cavity permits rotation of the spherical magnetic member while preventing user access to the spherical magnetic member from outside the body.

13. The method of claim 12, wherein the system element is a consonant letter block element having a generally rectangular body bearing at least one consonant character.

14. The method of claim 12, wherein the system element is a vowel hub element having a generally polygonal body bearing at least one vowel character.

15. The method of claim 12, wherein the spherical magnetic member remains rotatable within the fully enclosed internal cavity after the additive manufacturing process is completed.

16. The physical phonics learning system of claim 1, wherein the spherical magnetic members are further configured to enable magnetic attachment of at least one of the consonant letter block elements or vowel hub elements to a ferromagnetic support surface.

17. The physical phonics learning system of claim 1, wherein the body geometry of at least one system element is selected from triangular, rectangular, polygonal, circular, rounded, or irregular geometries.
